(19) United States
(12) Patent Application Publication
(10) Pub. No.: US 2010/0055296 A1
(43) Pub. Date: Mar. 4, 2010

(54) COATING INSTALLATION COMPRISING A RADIO DEVICE AND METHOD FOR CONTROLLING AN ACTUATOR OR A HEATER

(75) Inventors: Joachim Bankmann, Duderstadt (DE); Frank Eisenkrämer, Biebertal (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA MICROSYSTEMS CMS GMBH, Wetzlar (DE)

(21) Appl. No.: 12/517,048

(22) PCT Filed: Nov. 26, 2007
(86) PCT No.: PCT/EP2007/062810

§ 371 Date: Jul. 30, 2009

(30) Foreign Application Priority Data
Nov. 29, 2006 (DE) 10 2006 056 289.5

(51) Int. Cl. B05D 7/00; B05C 13/00; B05C 11/00

(52) U.S. Cl. 427/8; 118/500; 118/712; 118/58; 118/663

(57) ABSTRACT

A deposition apparatus and methods for controlling an actuator and a heating system in a deposition apparatus are proposed. The deposition apparatus comprises a deposition chamber and at least one substrate holder movably arranged within the deposition chamber for holding substrates to be coated. The deposition apparatus shall further comprise radio equipment having at least a first radio device which is connected to the substrate holder and a second radio device which is arranged at least partially outside the deposition chamber. Between the first radio device and the second radio device a radio link is to be established at least temporarily for transferring information.

The invention relates to a deposition apparatus comprising a deposition chamber and a substrate holder movably arranged within the deposition chamber and suitable for holding substrates to be coated. A deposition apparatus of this kind is known from EP 1 050 597 B1.

Thin layers with their various properties and functions have an important role in our modern daily routine. In particular, thin layers having an optical function, such as mirror layers, filter layers or anti-reflection layers, are becoming more and more important. Both individual layers and a series of several layers deposited on top of one another, so-called layer packages or multi-layers, are of interest. Thin layers and layer packages can be manufactured in deposition apparatuses on suitable substrates such as glass, ceramics or plastic material. For this purpose, a deposition apparatus comprises at least one deposition chamber in which both a substrate holder suitable for holding one or more substrates and a material source are arranged. Typically, the coating of the substrates takes place in an evacuated deposition chamber. The production of thin layers can, however, likewise take place in a gas atmosphere under a gas pressure that can be specifically chosen.

Often the substrate holder of a deposition apparatus is arranged in the deposition chamber such that a movement, preferably a rotation of the substrate holder results in a movement of the substrate(s) in the particle flow emitted by the material source. By means of a well-directed movement of the substrate or of several substrates in or through the particle flow of the material source, a defined coating of the substrates can be obtained. A deposition apparatus comprising a changeable rotating spherical cap as a substrate holder is known from EP 1 050 597 B1. This deposition apparatus is particularly suitable for coating spectacle lenses made of plastic material.

For quality assurance of the production, it is desirable to measure various characteristic parameters of the deposited layers if possible already during the deposition process. Given such a measurement, among other things optical parameters of the layers and/or the layer thickness are of interest.

DE 3610733 A1 discloses a device for measuring the optical properties of thin layers during their formation. In particular, the transmission behavior of optical layers is measured while the layer to be measured is deposited in a vacuum chamber. The layer to be measured is applied to a moving substrate which is preferably moved uniformly on a circular path. Measuring takes place by means of a measuring light beam which is stationary relative to the vacuum chamber. This measuring light beam makes it possible, owing to the uniform circular motion of the substrate, to record a measuring signal characteristic for the deposited layer for each fraction of the circular motion. The measuring concept disclosed in DE 3610733 A1, however, is not open to measurements which typically are to be made over a longer period of time. The technical problems with respect to the recording of such measuring data become greater the higher the speed at which the substrates to be measured are moved within the vacuum chamber. Further, with the afore-mentioned measuring concept it is not possible to obtain measuring data from layers that are not moved periodically or moved with very long periods in the vacuum chamber.

DE 4314251 A1 discloses a method and an apparatus for producing optically absorbing thin layers. According to this document a test substrate mounted stationarily in the vacuum chamber of a deposition apparatus is measured with respect to its optical properties. Measuring takes place by means of a measuring light beam which is stationary relative to the vacuum chamber. On the basis of the values measured on the test substrate or the thin layer applied to this test substrate conclusions are drawn on the properties of those layers which are deposited on the substrates rotating within the vacuum chamber. Thus, in this case the method concerned is an indirect measuring method. Such methods typically have incalculable measuring inaccuracies.

Not only the optical properties of thin layers are of interest, but also the substrate temperature represents an important physical quantity in the production of thin layers. Typically, the temperature in a deposition chamber is measured by means of a thermocouple which is stationarily arranged in the deposition chamber. The actual temperature of the substrates is estimated on the basis of this value.

EP 1 050 598 B1 discloses a vacuum deposition apparatus in which a temperature sensor revolves with the supports for the substrates to be coated. In this way, the temperature in the deposition plane can be sensed. The apparatus for temperature measurement as disclosed in EP 1 050 598 B1 comprises a first part which is connected to the stationary part of the deposition apparatus and a second part which is connected to the rotating spherical cap, i.e. the support for the substrates to be coated. The first and second parts are inductively coupled to one another. For an effective coupling of the primary coil and the secondary coil, one being a part of the stationary first part and the other one being a part of the moving second part of the apparatus for temperature measuring, it is necessary that the primary coil and the secondary coil are arranged coaxially and revolving relative to one another. As can directly be seen, the afore-mentioned apparatus for temperature measurement is technically expensive since it requires a primary coil and a secondary coil which are arranged concentrically to one another and which in addition are to be preferably arranged near the axis of rotation of the spherical cap. Further, the apparatus for temperature measurement as disclosed in EP 1 050 598 B1 can only be used for substrate holders that are pivotally mounted about a single axis. Accordingly, the above-described apparatus for temperature measurement is not suitable, for example, for vacuum deposition apparatuses in which the substrate holder is driven by a planetary gear, or in which the substrate holder is pivotally mounted about more than one axis.

U.S. Pat. No. 4,860,687 discloses a deposition apparatus with a rotatable substrate holder. The rotatable substrate holder is supported in a deposition chamber by means of a gas flow and rotated without one or more mechanical rotating units. The gas is supplied from the bottom of the substrate holder, and on the upper surface of the substrate holder there are the substrates to be coated. With respect to the previously described deposition apparatus, too, it might be desirable to measure the substrate temperature in the substrate plane. Obviously, however, the technology as disclosed in EP 1 050 598 is not applicable to an apparatus as disclosed in U.S. Pat. No. 4,860,687.

In addition to the possibility of characterizing the substrates already during the production process, there is further the wish to manipulate the substrates in a targeted way and already during the production process. Typically, the mechanical manipulation of substrates or the substrate holder takes place by means of slideways and/or rotating units. In the case of moving substrates a manipulation of the substrates by means of a heating system can only take place indirectly via a heating system stationarily mounted in the deposition chamber. If the substrate to be coated is positioned on a moving substrate holder, direct mechanical manipulation possibilities as well as a direct heating of the substrates cannot be considered in practice.

In a deposition apparatus, the substrates to be coated are typically only coated from one side. By turning the substrates by 180° in the deposition chamber, there is theoretically the possibility of coating twice the amount of surfaces in one single deposition cycle.

DE 37 15831 A1 discloses a vacuum deposition apparatus comprising a spherical cap-shaped substrate holder comprised of single turnable supporting plates. For turning the supporting plates over, they are connected at their rotary axes to a turn over-control curve means in the form of a shifting fork. This shifting fork cooperates with an actuating pin that can be temporarily moved into the revolving area of the supporting plate, and thus effects the turn-over of the supporting plate. A deposition apparatus having the substrate supporting means as disclosed in DE 37 15831 A1 is obviously technically expensive since a sensitive cooperation of actuating pin and shifting fork is necessary for the functioning of the turn-over mechanism. Moreover, the position of the axis of rotation, about which the supporting plates can be turned, is not optional, it is obviously dependent on the position of the supporting plates in the spherical cap-shaped substrate holder.

The object of the present invention is to specify a deposition apparatus which is provided with means which allow in a simple and flexible way, on the one hand, to communicate information from a position within the deposition chamber to a position outside the deposition chamber and, on the other hand, to communicate commands from a position outside to a position within the deposition chamber.

This object is solved for an apparatus by the measures indicated in claim 1. The object is solved for a method by the measures indicated in claims 27 and 28. The invention is based on the recognition to use, in contrast to the solutions known from the prior art, a radio link in order to, on the one hand, transfer data and information gained within a deposition chamber to a position outside this deposition chamber, and, on the other hand, to communicate orders/commands from a position outside the deposition chamber to a position within the deposition chamber.

What is to be specified according to the invention is a deposition apparatus comprising a deposition chamber and a substrate holder movably arranged within the deposition chamber for holding substrates to be coated. The deposition chamber shall further have radio equipment comprising at least two radio devices, at least a first radio device being connected to the substrate holder and at least a second radio device being at least partially arranged outside the deposition chamber. Between the radio devices a radio link shall at least be temporarily established for transferring information between the first and the second radio device.

The advantages associated with the afore-mentioned embodiment of the deposition apparatus can particularly be seen in that it is possible by means of radio equipment to exchange information between a position inside and outside the deposition chamber independent of the movement of the substrate holder. By means of the inventive embodiment of the deposition apparatus, it is possible to overcome the technical problems of a wire-bound transmission of information. For example, a cable mounted within the deposition chamber for the transmission of information can have an influence on the movement of the substrate holder, or the moving substrate holder could damage the transmission cable. If the substrate holder is rotated within the deposition chamber, the use of sliding contacts would be possible in order to transmit information in a wire-bound manner. However, sliding contacts have a low reliability. If a sliding contact is used in a deposition apparatus, then its reliability is additionally worsened as a result of the material deposited in the deposition chamber.

There is the possibility of exchanging energy in a wireless way between a rotating substrate holder and a fixed point within a deposition chamber by means of a device comprising two inductively coupled coils. Such a solution is, however, merely suitable for such deposition apparatuses in which a substrate holder is rotated about a fixed axis with a uniform movement. Both coil pairs of such a device are arranged within the deposition chamber. For this reason, such a device has at least the same technical problems as, for example, the sliding contacts, as a result of the material deposited in the deposition chamber.

Advantageous embodiments of the inventive deposition apparatus result from the claims dependent on claim 1. The embodiment according to claim 1 can be combined with the features of a subclaim or also preferably with those of several subclaims. Accordingly, the deposition apparatus can additionally have the following features:
To the first radio device an actuator can be connected which is in operative connection with the first radio device and is connected to the substrate holder. The information transmitted via the radio link can further include control commands for the actuator. By means of the above embodiment of the deposition apparatus, a well-directed manipulation of individual parts present on the substrate holder can take place. Thus, for example, various linear or rotary movements can be performed with respect to one or several substrates. Likewise advantageously, forces can be exerted on various parts of the substrate holder or on parts connected therewith.
The actuator can control at least one shield connected to the substrate holder for interruption of a material flow starting out from a material source arranged within the deposition chamber. Advantageously, by means of a shield connected to the substrate holder the material flow for a single substrate or a group of substrates can be interrupted. In this way, different layer thicknesses or layer sequences can be produced on substrates in one deposition cycle with one and the same substrate holder.
The actuator can effect a turn of a least one substrate. Advantageously, one single substrate or a group of substrates can be turned during the ongoing deposition process; thus an individual coating for a single substrate or a group of substrates can be achieved. A single substrate or a group of substrates can typically be coated only from one side during the deposition process. If the substrate or the substrates are turned during the deposition process, a coating from several sides can be achieved.
At least parts of the substrate holder can be turnable by almost 180° by means of the actuator. Advantageously, by way of a 180° turn of at least parts of the substrate holder, the substrates supported by this part of the substrate holder can be coated on opposite sides in one single production process.
At least parts of the substrate holder can be rotatable about an axis, and can be supported relative to a reference frame without the use of an axle by means of at least one spring twisted substantially coaxially to the axis. Advantageously, by the previously described mounting of at least parts of the substrate holder, the reliability of the substrate holder with respect to the free and uninterrupted rotation of at least parts of the substrate holder can be improved. A suspension of at least parts of the substrate holder without the use of an axle reduces the problems that can occur in deposition apparatuses when a bearing or the like is exposed to a material flow. Owing to material depositing on or within the bearing the free rotation can be restricted.
At least parts of the substrate holder can be biased relative to the reference frame by means of the at least one twisted spring. The 180° turn of at least parts of the substrate holder can be effected while reducing the biasing of the at least one twisted spring. Advantageously, by way of the previously described embodiment of at least parts of the substrate holder, these can be turned simply and effectively. For example, the function of the actuator can merely consist in a release of the rotation, as a result whereof the actuator can be designed simply and cost-efficiently.
To the first radio device at least one heating system can be connected which is in operative connection with the first radio device and is connected to the substrate holder. Further, the information transmitted between the radio devices can contain control commands for the heating system. In a deposition apparatus according to the above embodiment, by means of the heating system connected to the substrate holder a single substrate or a group of substrates can be heated up to a desired temperature. Advantageously, by way of direct heating of the substrate or the substrates their temperature can be set more precisely than this would be possible with an indirect heating.
In addition to the actuator and/or a heating system, the first radio device can also be connected to a measuring device. A deposition apparatus according to the above embodiment allows for a control of the actuator and/or the heating system on the basis of the measurement results of the measuring device. Advantageously, the actuator and/or the heating system can be controlled in a feedback control circuit on the basis of the measurement results of the measuring device.
The measuring device can be suitable for measuring at least one physical quantity of a group of physical quantities, comprising a substrate temperature, a gas pressure, an electrical voltage, an electrical resistance or a layer thickness of a layer deposited on a substrate to be coated. Further, at least one of these physical quantities can be a control parameter of the actuator and/or the heating system. The afore-mentioned physical quantities represent important process parameters in the production of thin layers. A measurement of such physical quantities on a moving substrate or on the thin layer present on the moving substrate is not possible by means of conventional contact-free measuring processes. Advantageously, according to the above described embodiment of the deposition apparatus a particularly effective, simple and cost-efficient way for such measurements can be specified. Further advantageously, the actuator and/or the heating system can be controlled on the basis of one or more of these physical quantities.
The first radio device, the actuator and/or the measuring device can be provided with means for thermal insulation. For a specific production of specific layers temperatures can prevail in the deposition chamber of a deposition apparatus which are above the critical temperature from which electronic circuits are typically permanently damaged. By a thermal insulation of the first radio device, the actuator and/or the measuring device their reliability when used within a deposition chamber as described above can be improved.
The first radio device, the actuator and/or the measuring device can be accommodated in a vacuum-insulated housing. When producing thin layers, the necessity can arise to evacuate the deposition chamber. By way of a vacuum insulation, on the one hand, the electronics of the measuring device, of the actuator and/or of the radio device can be protected against the vacuum, for example, a gassing of certain component parts can be prevented. On the other hand, the insulating vacuum prevailing in the deposition chamber can be protected against undesired contamination that can be caused by gassing electronic component parts.
The first radio device, the actuator and/or the measuring device can be accommodated in a common housing. What is particularly advantageous is that by accommodating the radio device, the actuator and/or the measuring device in one common housing, the technical expense for the integration of the respective component parts into the deposition chamber can be reduced.
The substrate holder can be rotatable about a fixed axis and designed as a spherical cap. By way of designing the substrate holder in the form of a spherical cap, a homogeneous coating of the substrates supported by the spherical cap can be achieved. For the homogeneous and thus high-quality thin layers produced in this way, it is particularly interesting to gain, for example, measured values for the characterization of the layers. Further advantageously, in a deposition apparatus according to the above embodiment, the substrates can, for example, be heated.
In the deposition chamber a planetary gear rotatable about a fixed axis can be arranged. The planetary gear can further be suitable for putting at least one substrate holder into rotation about an axis parallel to the axis of the planetary gear. Planetary gears make it possible to set the substrates mounted on the substrate holder/s into a motion having a very long period. That means, only after a very long time, the substrates repeatedly reach the same point in the deposition chamber. In this way, a very homogeneous coating of the substrates can be achieved. The measuring device mounted on the substrate holder makes it possible to record measured values on the layers produced in the above-described manner. Further, an actuator, for example, allows turning of one or more substrates and a heating system allows heating thereof. Particularly advantageously, by the use of a radio link for transmitting measured values and/or for controlling an actuator and/or a heating system, the problems of a wire-bound transmission of measured values from substrates moving almost irregularly can be overcome.
The carrier frequency of the radio link can be an ISM frequency (Industrial, Scientific and Medical). Preferably, the carrier frequency can be 27 MHz, 40 MHz, 446 MHz, 860 MHz or 2.45 GHz. Further, the radio link can be a digital radio link. Advantageously, an ISM frequency can be used for the radio link since these frequencies can be used free of registration and free of charge. An interference of other electronic component parts of the deposition apparatus can likewise be largely avoided. A digital radio link further allows for an improved error correction and thus has an advantageous effect on the reliability of the information transfer.
The deposition chamber can be evacuated up to a high or ultrahigh vacuum. For producing high-quality thin layers a suitable insulating vacuum is required. Typically, such an insulating vacuum is a high or ultrahigh vacuum. The measurement of physical quantities near or directly on a substrate or on the layer applied to the substrate is above all desirable in the case of high-quality layers. Particularly advantageously, thus, the deposition chamber of the deposition apparatus comprising radio equipment and a measuring device can be evacuated up to a high or ultrahigh vacuum. The same or similar advantages as result for a measurement in a deposition chamber also result for the control of an actuator and/or a heating system.
The substrates may have to be coated with a thin layer, the layer thickness of which lies between 3 nm and 100 μm, in particular between 50 nm and 100 μm. Thin layers within the range of layer thicknesses previously stated are particularly interesting for a technical application. Consequently, from a commercial point of view, it is particularly advantageous to design the deposition apparatus such that it is suitable for producing thin layers within the mentioned range of layer thicknesses.
The substrates may have to be coated with a material which contains at least one material component from a group of material components comprising SiO2, TiO2, HfO, TaO, MgF2, Al2O3, ZrO2, PrTiO3, ZnS. The afore-mentioned materials are above all relevant for coatings as they are interesting for optical applications. A measurement of physical quantities directly on a substrate holder is above all particularly interesting for the high-quality layers as used for optical applications. Likewise, the control of an actuator and/or a heating system for processes in which the afore-mentioned layers are produced, is particularly interesting.
The substrates may have to be coated with a metallic material. Metallic layers may represent a special case of optical layers for a specific wavelength range, such as XUV or the X-ray range, thus there are the same advantages as in the previous paragraph.
The substrates may have to be coated with a multi-layer system of different materials. Multi-layer systems are complex coatings which are of particular interest for high-quality optical applications. Measurements of physical quantities as well as the control of an actuator and/or a heating system directly on the substrate holder are thus particularly interesting for such multi-layer systems.

Further an inventive method for controlling an actuator is to be specified. The actuator shall be arranged in the deposition apparatus, the deposition apparatus comprising at least one deposition chamber and at least one substrate holder movably arranged within the deposition chamber for holding substrates to be coated, as well as radio equipment having at least a first radio device which is connected to the substrate holder, and a second radio device which is arranged at least partially outside the deposition chamber. The method for controlling the actuator shall comprise the following steps. Recording at least one measured value by means of a measuring device connected to the substrate holder; transferring the at least one measured value via a radio link established at least temporarily between the first and second radio device; processing the at least one measured value in a data processing unit connected to the second radio device into at least one control command; transferring the at least one control command via the radio link established at least temporarily between the first and the second radio device to the actuator. According to the above method, the actuator can be controlled based on a measured value which is directly measured on the substrate holder. Advantageously, by this method a feedback control of the actuator can be achieved. For example, by means of the measuring device a layer thickness on a moving substrate can be measured. Based on this information, a turn of this substrate can be effected by means of the actuator. When the same layer thickness is reached on the rear side of the substrate, which is measurable by the measuring device, then by means of the actuator a shield can be used which interrupts the material flow to the substrate concerned. In this way, by means of the afore-mentioned method, for example, substrates having different layer thicknesses can be produced in one coating operation and on one and the same substrate holder.

Further, an inventive method for controlling a heating system is to be specified. The heating system is to be arranged in a deposition apparatus, the deposition apparatus comprising at least one deposition chamber and at least one substrate holder movably arranged within the deposition chamber for holding substrates to be coated, as well as radio equipment having at least a first radio device connected to the substrate holder and a second radio device arranged at least partially outside the deposition chamber. The method for controlling the heating system shall comprise the following steps: recording at least one measured value by means of a measuring device which is connected to the substrate holder; transferring the at least one measured value via a radio link established at least temporarily between the first and second radio device; processing the at least one measured value in a data processing unit connected to the second radio device into at least one control command; transferring the at least one control command via the radio link established at least temporarily between the second and the first radio device to the heating system. According to the above method, a heating system connected to the substrate holder and possibly jointly moved therewith in the deposition chamber can be controlled based on a measured value recorded by a measuring device which can likewise be moved in the deposition chamber together with the substrate holder. In this way, for example, the temperature of a substrate can be measured. Based on this measured value, the temperature of the respective substrate can be individually set and controlled by means of the heating system.

Further advantageous embodiments of the inventive deposition apparatus are apparent from the subclaims not mentioned above as well as in particular from the drawings.

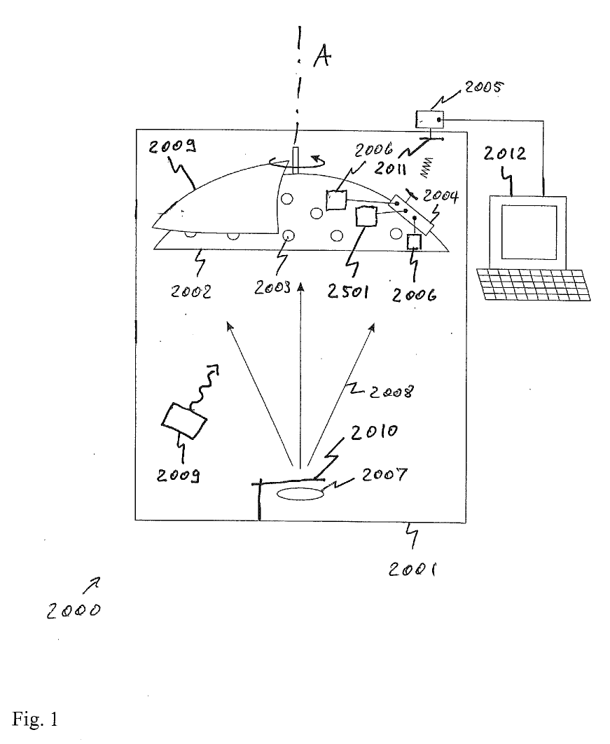

FIG. 1 shows a deposition apparatus comprising a spherical cap as a substrate holder and radio equipment integrated in the deposition apparatus for the transfer of information.

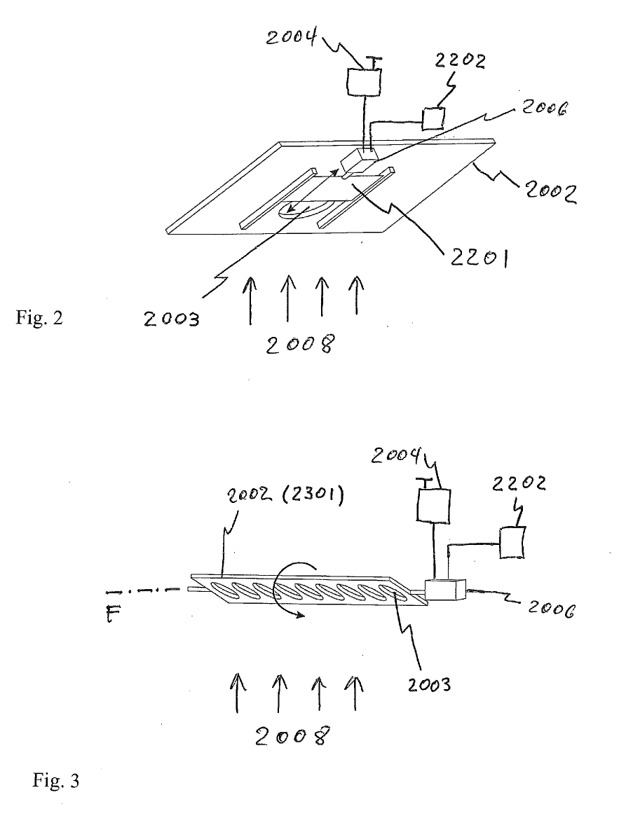

FIG. 2 is a perspective view of a substrate holder having a shield for shielding a material flow.

FIG. 3 is a perspective view of a substrate holder which can be turned over by means of an actuator.

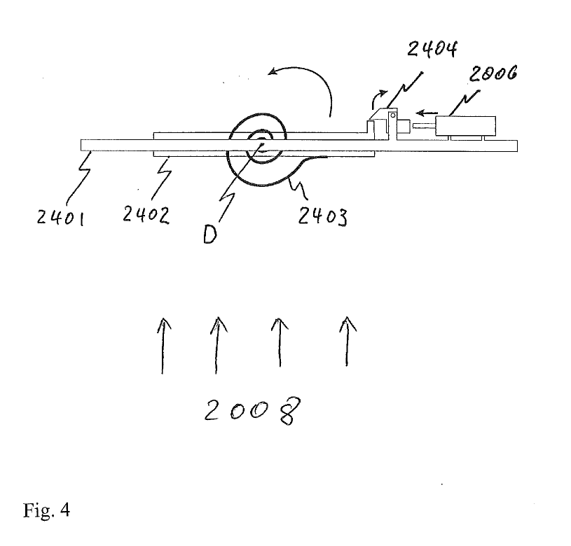

FIG. 4 is a cross-section of a substrate holder, a part of the substrate holder being supported relative to a reference frame by a twisted spring.

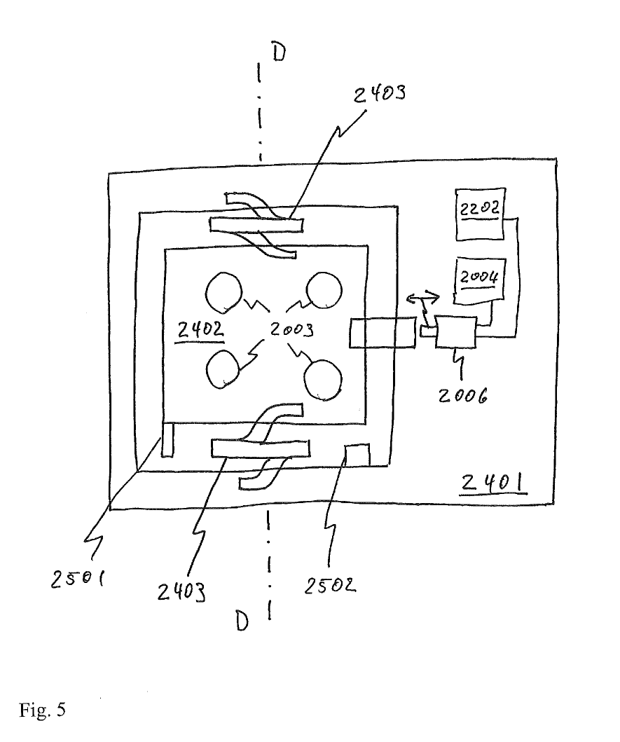

FIG. 5 is a top view of the substrate holder of FIG. 4.

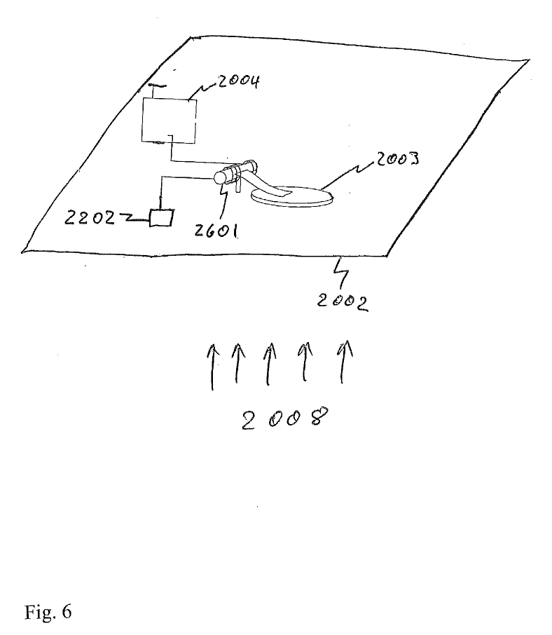

FIG. 6 shows a substrate holder having a heating system.

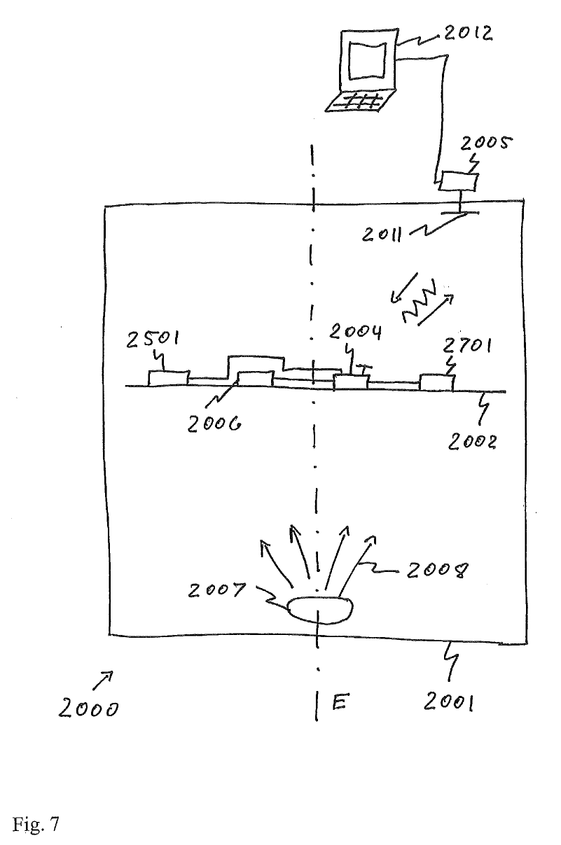

FIG. 7 shows a deposition apparatus comprising a rotatable substrate holder, a radio device, a measuring device, an actuator and a heating system being connected to the substrate holder.

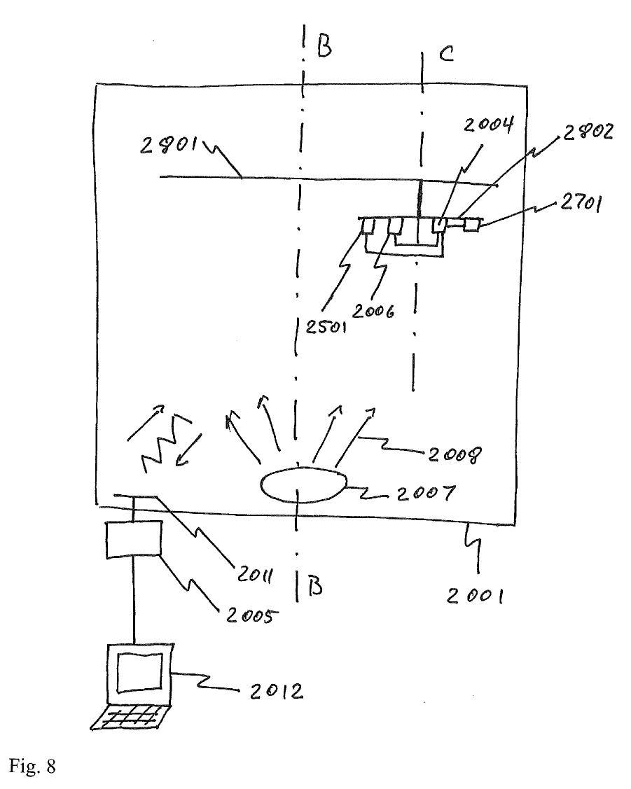

FIG. 8 shows a deposition apparatus having a substrate holder driven by a planetary gear.

Corresponding elements in the figures have identical reference signs.

FIG. 1 shows a deposition apparatus 2000 according to a preferred embodiment. The deposition apparatus 2000 comprises at least one deposition chamber 2001 in which a substrate holder 2002 arranged rotatably about an axis A is arranged. The deposition chamber 2001 can be evacuated up to a pressure of typically less than 10−5 mbar. During a deposition operation, a pressure of about 10−4 mbar typically prevails in the deposition chamber 2001. An increase of the pressure in the deposition chamber 2001 from about 10−5 mbar to about 10−4 mbar can preferably be realized by supplying oxygen into the deposition chamber 2001. Preferably, the substrate holder 2002 can be designed in the form of a spherical cap or a rotating spherical cap. In this case, the axis A can coincide with the symmetry axis of the rotating spherical cap.

The substrate holder 2002 is suitable for holding substrates 2003 to be coated. As substrates, arbitrary glasses but also metallic or ceramic materials are suitable. Preferably, CaF2 or SiO₂ can be used as a substrate glass. Likewise, as a substrate one of the following materials can be used: MgF2, Al2O3, ZrO2, PrTiO3, TiO2, ZnS.

According to the embodiment illustrated in FIG. 1, the coating of the substrates 2003 takes place by means of a material source 2007. The material source 2007 can preferably be located in the bottom region of the deposition chamber 2001. The material source 2007 can be an evaporator crucible, a sputtering cathode or another generally known material source suitable for thin film methods. Starting out from the material source 2007, material exiting therefrom is deposited in the direction of the bottom side of the substrate holder 2002, as illustrated by arrows in FIG. 1. As a consequence, the substrates 2003 are coated from this side. The coating of the substrates 2003, can, as illustrated in FIG. 1, take place with one single material source 2007. Several material sources 2007 can likewise be used for the coating of the substrates 2003. Given a coating of the substrates 2003 with the aid of several material sources 2007, these can be arranged in the bottom region of the deposition chamber 2001. Further, one or more material sources 2007 can be arranged both in the bottom as well as in the ceiling region of the deposition chamber 2001. By using several material sources 2007 for coating the substrates 2003, the substrates can be coated simultaneously with several material components. By arranging one material source 2007 in the bottom region of the deposition chamber 2001 and a further material source 2007 in the ceiling region of the deposition chamber 2001, a two-sided coating of the substrates 2003 can be achieved.

The layer thicknesses of the layers to be produced in the deposition chamber 2001 can vary dependent on the requirements on the layers to be produced. The layer thicknesses of individual layers can typically range from a few nanometers (about 1 to 3 nm) up to several ten micrometers (about 20 to 100 μm). Further, by means of multi-layer systems optical mirrors can be produced. Depending on whether a mirror produced in this way is to reflect in the ultraviolet or in the infrared spectral region, the layer thickness of an individual layer of the multi-layer system varies between about 10 nm and about 1 to 2 μm. The layers to be produced in the deposition chamber 2001 can further be densified or post-densified by an ion bombardment taking place during and/or after the deposition.

The substrate holder 2002 can rotate about the axis A at a typical rotational speed of 40 to 60 rpm, preferably at a rotational speed of 30 to 50 rpm. The rotation of the substrate holder 2002 is useful for the uniform coating of the substrates 2003. The rotational speed can be adapted to the respective requirements for achieving optimum deposition results, and also beyond the above ranges.

For a further well-directed influencing of the deposition conditions, heating systems 2009 can be arranged in the deposition chamber 2001. What is possible is the installation of one or more heating systems 2009 in an arbitrary position relative to the substrate holder 2002. Preferably, radiation heating systems can be used, but other generally known heating systems can be used as well. The heating system 2009 can be arranged in the lower region of the deposition chamber 2001. It can also have the form of a heating plate extending above the substrate holder 2002.

The material source 2007 can be provided with a shield 2010 by means of which the material flow 2008 coming from the material source 2007 can be interrupted.

The deposition apparatus 2000 is further provided with radio equipment consisting of at least two radio devices. A first radio device 2004 is connected to the substrate holder 2002. One or more actuators 2006 and/or one or more heating systems 2501 can be connected to this first radio device 2004.

In the following at first embodiments with respect to actuators 2006 connected to the first radio device 2004 are explained; embodiments with respect to heating systems 2501 connected to the first radio device 2004 are explained in connection with FIG. 5.

In addition to the first radio device 2004 connected to the substrate holder 2002, a second radio device 2005 is integrated into the deposition system 2000. The second radio device 2005 is located at least partially outside the deposition chamber 2001. For the transfer of information and data via the radio link, one or more antennas 2011 can be mounted within the deposition chamber 2001, which antennas are connected to the second radio device 2005. The radio link can be designed mono-directional, i.e. one of the two radio devices 2004, 2005 is always the sender and the corresponding other radio device is always the receiver. The radio link can also be designed bidirectional, i.e. both radio devices 2004, 2005 are senders as well as receivers. Further, the radio link can be an analog or digital radio link. Preferably, the radio link is a digital radio link having a frequency of about 27 MHz, 40 MHz, 446 MHz, 869 MHz or 2.45 GHz. These frequencies belong to the so-called ISM frequencies (Industrial, Scientific and Medical). Likewise other non explicitly mentioned ISM frequencies can be used as carrier frequencies for the radio link between the first radio device 2004 and the second radio device 2005.

For the control of the second radio device 2005 or, respectively, for the processing of information and data which the second radio device 2005 receives, the radio device 2005 can be connected to a data processing unit 2012.

FIG. 2 preferably shows a part of a substrate holder 2002. It can be a substrate holder 2002 which, as illustrated in FIG. 1, has the form of a rotating spherical cap. However, it can likewise be a part of an arbitrarily otherwise shaped substrate holder 2002. The substrate holder 2002 shall be suitable for holding substrates 2003 to be coated. The substrates 2003 are exposed to a material flow 2008. By means of this material flow 2008 a layer is applied to one side of the substrate 2003.

As already explained in connection with FIG. 1, the material flow 2008 starting out from the material source 2007 can be interrupted by a shield 2010. The shield 2010 is located centrally in front of the material source 2007, i.e. the material source 2007 can be interrupted by means of this shield 2010 globally for all substrates 2003 which are coated by the respective materials source 2007.

It is now desirable to not only interrupt the material flow 2008 globally, i.e. in case of doubt for all substrates 2003 present in the deposition chamber 2001 and held by the substrate holder 2002, but to interrupt the material flow 2008 individually for one single substrate 2003 or a group of substrates 2003. In order to comply with this desire, there is, in accordance with the embodiment illustrated in FIG. 2, a shield 2201 connected to the substrate holder 2002. By means of this shield 2201 it is possible to shield a single substrate 2003, as illustrated in FIG. 2, but also a group of substrates 2003 against the material flow 2008. The shield 2201 can shield the substrate(s) 2003 against the material flow 2008 by means of a linear or rotary movement. Such a shield 2201 can particularly be used in connection with a moving substrate holder 2002. Therefore, an actuator 2006 as well as a power supply 2202 for the actuator 2006 can likewise be connected to the substrate holder 2002. The actuator can be an electric motor, a linear motor or further generally known actuators such as a piezoelectric element or a shape memory element. The actuator 2006 is connected to the first radio device 2004 which is likewise connected to the substrate holder 2002. By means of the afore-described apparatus, one or more substrates 2003 can be shielded against the material flow 2008 during the ongoing deposition process. The shield 2201 moved together with the substrate holder 2002 preferably in the deposition chamber 2001 can be controlled from a position outside the deposition chamber 2001, for example, from a data processing unit 2012. In this way, it is possible to produce various products in one coating process. Thus, for example, glasses can be provided with differently thick coatings. Costly waiting times, for example, for pumping out the deposition chamber 2001 or for adjusting the material source 2007 can be omitted with the above embodiment.

FIG. 3 shows a substrate holder 2002 or a part of a substrate holder 2301 which is turnable about an axis F by means of an actuator 2006. A substrate holder 2002, preferably a spherical cap-shaped substrate holder 2002, as shown in FIG. 1, can include several elements/parts 2301 of the one shown in FIG. 3. In the following, the element 2301 is generally referred to as a substrate holder. The substrate holder 2301 is suitable for holding substrates 2003 to be coated. Preferably, the substrate holder 2301 moves in a material flow 2008. The substrates 2003 held by the substrate holder 2301 are coated on their side facing the material flow 2008. After the desired layer thickness has been applied to the substrates 2003, the substrate holder 2301 and together with it the respective substrates 2003 can be turned about the axis F. There can preferably be a turn of 180° so that after the turn the opposite side of the substrates 2003 is hit by the material flow 2008 and thus coated. For turning the substrate holder 2301, an actuator 2006 is connected therewith. Preferably, the actuator 2006 can be an electric motor. The actuator 2006 is, on the one hand, connected to a power supply 2202 and, on the other hand, connected to the first radio device 2004. For the control of the actuator 2006, control commands can be sent to the actuator 2006 from a position outside the deposition chamber 2001, for example, from a data processing unit 2012 via the radio link established at least temporarily between the second radio device 2005 and the first radio device 2004. By means of a deposition apparatus 2000 according to the above embodiment, it is possible to turn single substrates 2003 or, as shown in FIG. 3, a group of substrates 2003 during the ongoing deposition process and, thus, to provide for a two-sided coating of the substrate 2003. The substrates 2003 can likewise be continuously rotated, for example, in order to achieve a particularly good homogeneity of the layer or layers applied to the front and the rear side of the substrates 2003.

A substrate holder 2301, as illustrated in FIG. 3, can also be a segment 2301 of a larger substrate holder 2002. For example, an almost spherical cap-shaped substrate holder 2002 can consist of segments 2301, the rotational axes F of which are oriented radially or star-shaped with respect to the spherical cap. In this case, the individual segments 2301 of an almost spherical cap-shaped substrate holder 2002 can be turned independently of one another.

FIG. 4 shows a part of a substrate holder 2002 according to a further embodiment. The arrangement shown in FIG. 4 can be a part of a spherical cap-shaped substrate holder 2002, it can, however, likewise be a part of an arbitrarily otherwise shaped substrate holder 2002. The arrangement shown in FIG. 4 consists at least of a reference frame 2401 and a moving substrate holder 2402, which bears against the reference frame 2401 by at least one twisted spring 2403. The reference frame 2401 can, for example, be part of a spherical cap-shaped substrate holder 2002, as shown in FIG. 1 and referenced with 2002. The twisted spring 2403 can be a generally known twisted leaf spring or another generally known spring 2403 suitable for the present embodiment. With respect to the reference frame 2401, the substrate holder 2402 is rotatably mounted substantially about an axis D. The mounting of the substrate holder 2402 with respect to the reference frame 2401 is realized by means of two twisted springs 2403 without a mechanical axle, i.e. the substrate holder 2402 merely bears against the reference frame 2401 by means of the twisted springs 2403. This becomes particularly clear when combining FIG. 4 and FIG. 5. A mounting of the substrate holder 2402 with respect to the reference frame 2401 without an axle is particularly advantageous for deposition systems. Axle bearings tend to block or to exhibit malfunctions in particular when the area of the axle bearing is exposed to the material flow 2008. The material deposited in the area of the bearing gap or directly within the bearing gap can reduce the free rotation of the axle.

The substrate holder 2402 is suitable for holding one or more substrates 2003 to be coated. The substrates 2003 are exposed to a material flow 2008 for their coating. Since the substrates 2003 are in this case typically only coated from one side, it is desirable to turn the substrates 2003 or the substrate holder 2402 holding the substrates 2003 by preferably 180° with respect to the material flow 2008. According to one embodiment, this can be effected in a particularly simple and effective way with the afore-described substrate holder 2402.

The substrate holder 2402 can be biased against the reference frame 2401 by the spring force of the twisted spring 2403. The substrate holder 2402 is held in a rest position with respect to the frame 2401 by a locking device 2404. The locking device 2404 can be unlocked by the actuator 2006 so that the substrate holder 2402 is released for an almost 180° turn with respect to the reference frame 2401. For this purpose, the mechanical structure of the locking device 2404 and the actuator 2006 indicated in FIG. 4 can be used. Likewise, another generally known mechanical structure fulfilling the same purpose, namely a locking of the biased substrate holder 2402, for example, a locking in the form of a bar, can be used.

Driven by the biasing of the twisted spring 2403, the substrate holder 2402 makes an almost 180° turn and at the end of this turn, is locked by two elements acting as stops. A stop element 2501 connected to the substrate holder 2402 comes into contact with a stop element 2502 connected to the reference frame 2401.

FIG. 6 shows a part of a substrate holder 2002 having a heating system 2601 according to a further embodiment. The part of the substrate holder 2002 illustrated in FIG. 6 can again be a part of a spherical cap-shaped substrate holder 2002, however, every otherwise shaped substrate holder 2002 can likewise be used. The substrate 2003 held by the substrate holder 2002 is preferably connected thermally to a heating system 2601 with its side facing away from the material flow 2008. Typically, the heating system 2601 can be a resistance heating which is connected to the substrate 2003 directly or indirectly. The heating 2601 is connected, on the one hand, to the power supply 2202 and, on the other hand, to the first radio device 2004. In this way, the heating system 2601 can be controlled from a position outside the deposition chamber 2001. In a deposition apparatus 1000 according to the above embodiment, the temperature of individual substrates 2003 or a group of substrates 2003 can be controlled individually, for example, by a data processing unit 2012 outside the deposition chamber 2001.

FIG. 7 shows a deposition apparatus 2000 according to another embodiment. The deposition apparatus 2000 has at least a deposition chamber 2001 and a substrate holder 2002 arranged rotatably within the deposition chamber 2001. The substrate holder 2002 is rotatably mounted about an axis E and can preferably be designed in the form of a spherical cap.

To the substrate holder 2002 a first radio device 2004 as well as an actuator 2006, a heating system 2601 as well as a measuring device 2701 can be connected. According to other embodiments, which are not to be explained here in more detail, the substrate holder 2002 can be connected to a measuring device 2701 and an actuator 2006 or a measuring device 2701 and a heating system 2501.

The actuator 2006 can be designed according to one of the embodiments illustrated in FIGS. 2 to 5, the heating system 2501 can be designed according to the embodiment illustrated in FIG. 6. The measuring device 2701 can in particular be connected to measuring probes for measuring various physical quantities. By means of one of these measuring probes, in particular, the temperature of one or more substrates 2003 can be measured. Preferably, a thermocouple such as a Ni/NiCr thermocouple can be used as a temperature measuring probe. According to further embodiments, further physical quantities within the deposition chamber 2001 can be measured by means of the measuring device 2701. For this purpose, further measuring probes can be connected to the measuring device 2701. These further measuring probes can be suitable for measuring gas pressures, current intensities, voltages, resistances, forces and/or further physical quantities. The measuring probes can be directly brought into contact with the substrates 2003 or the layer deposited on the substrates 2003. Likewise, the measuring probes can be brought near the substrates 2003 and/or be in thermal or mechanical contact with the substrate holder 2002. A complex measuring probe can be an oscillating crystal for determining the layer thickness. The frequency of the oscillating crystal can be read out with the aid of the measuring device 2701. In this way, the deposited mass or the deposited layer thickness can directly be measured at a defined position on the substrate holder 2002. A further possibility for the design of a measuring probe is a device with which the layer thickness deposited on the substrate 2003 can be measured. This can, for example, take place with the aid of an interferometric measurement. In this case, the measuring probe consists of at least one light source, for example an LED or laser diode, and a photo detector. The measurement of the layer thickness on the substrate 2003 takes place, as is generally known from the prior art, on the basis of the analysis of the intensity maxima and minima of the light portion of the light source reflected on the respective layer.

One or more measured values recorded by the measuring device 2701 within the deposition chamber 2001 can be transferred via the radio link established between the first radio device 2004 and the second radio device 2005 arranged at least partially outside the deposition chamber 2001. A data processing unit 2012 can be connected to the second radio device 2005. With the aid of the data processing unit 2012, the measured values received can be processed into control commands for the heating system 2501 and/or the actuator 2006. These control commands can be sent to the actuator 2006 and/or the heating system via the second radio device 2005 and the first radio device 2004.

By means of a deposition apparatus 2000 according to the above embodiment a feedback control of the actuator 2006 and/or the heating system 2501 can take place. For example, with the aid of the measuring device 2701, a substrate temperature can be determined. This measured value can be compared to a specified desired value by means of the data processing unit 2012 and from this comparison, the control commands for the heating system 2501 can be calculated so that the substrate temperature can be measured and controlled for each individual substrate or a group of substrates 2003. Further, for example with the aid of the measuring device 2701 a layer thickness at one or more substrates 2003 can be measured. Based on this measured value, a control command for the actuator 2006 can be calculated by means of the data processing unit 2012. The actuator 2006 can, for example, provide that a turn of one or more substrates 2003 is performed or that a shield 2201 for shielding the respective substrates 2003 can be moved into the material flow 2008.

FIG. 8 shows a deposition apparatus 2000 according to another embodiment. Compared to the embodiments known from the preceding figures, a planetary gear 2801 is arranged in the deposition chamber 2001. This planetary gear 2801 is rotatably mounted about an axis B. With the aid of the planetary gear 2801, a substrate holder 2802 can be rotated about an axis C. The planetary gear 2801 can be suitable for driving one or more substrate holders 2802. The axes B and C can still preferably run parallel. Further, the axes B and C can have an angle to one another that can be firmly set. In an identical or very similar way, as shown in connection with the preceding figures, in the embodiment shown in FIG. 8, too, a first radio device 2004, an actuator 2006, a heating system 2501 and/or a measuring device 2701 can be connected to the substrate holder 2801. Likewise, as described in connection with FIG. 7, according to the embodiment shown in FIG. 8, a control of the actuator 2006 and/or of the heating system 2501 based on one or more measured values of the measuring device 2701 can be performed, too.

1. A deposition apparatus comprising:
a deposition chamber;
at least one substrate holder movably arranged within the deposition chamber for holding substrates to be coated;
radio equipment having at least:
a first radio device which is connected to the substrate holder, and
a second radio device which is arranged at least partially outside the deposition chamber; and
a radio link for transferring information being established at least temporarily between the first radio device and the second radio device.

2. The deposition apparatus according to claim 1, wherein at least one actuator is connected to a first radio device and said actuator is in operative connection with the first radio device and is connected to the substrate holder.

3. The deposition apparatus according to claim 2, wherein the information includes control commands for the actuator.

4. The deposition apparatus according to claim 3, wherein the actuator controls at least one shield connected to the substrate holder for interrupting a material flow coming from a material source arranged within the deposition chamber.

5. The deposition apparatus according to claim 3, wherein the actuator effects turning of at least one substrate.

6. The deposition apparatus according to claim 5, wherein at least parts of the substrate holder can be turned by almost 180° by means of the actuator.

7. The deposition apparatus according to claim 6, wherein at least parts of the substrate holder can be turned about an axis and are supported relative to the reference frame without the use of an axle by means of at least one spring twisted substantially coaxially to the axis.

8. The deposition apparatus according to claim 7, wherein at least parts of the substrate holder are biased relative to the reference frame by means of the at least one twisted spring, and the 180° turn of at least parts of the substrate holder is effected while reducing the bias of the at least one twisted spring.

9. The deposition apparatus according to claim 1, wherein at least one heating system is connected to the first radio device and said heating system is in operative connection with the first radio device and is connected to the substrate holder.

10. The deposition apparatus according to claim 9, wherein the information includes control commands for the heating system.

11. The deposition apparatus according to claim 2, wherein the first radio device is connected to a measuring device that is in operative connection with the first radio device and is connected to the substrate holder.

12. The deposition apparatus according to claim 11, wherein the measuring device is suitable for measuring at least one physical quantity from a group of physical quantities comprising a substrate temperature, a gas pressure, an electrical voltage, an electrical resistance, or a layer thickness of a layer deposited on a substrate to be coated.

13. The deposition apparatus according to claim 12, wherein at least one physical quantity is a control parameter of at least one of the actuators and the heating system.

14. The deposition apparatus according to claim 11, wherein at least one of the group consisting of the first radio device, the actuator and the measuring device are equipped with means for thermal insulation.

15. The deposition apparatus according to claim 11, wherein at least one of the group consisting of the first radio device, the actuator and the measuring device are accommodated in a vacuum-insulated housing.

16. The deposition apparatus according to claim 11, wherein at least one of the group consisting of the first radio device, the actuator and the measuring device are accommodated in a common housing.

17. The deposition apparatus according to claim 1, wherein the substrate holder is designed as a spherical cap rotatable about an axis.

18. The deposition apparatus according to claim 1, wherein in the deposition chamber a planetary gear rotatable about a main axis is arranged, which planetary gear is suitable for rotating at least the substrate holder connected to the planetary gear about an axis which is oriented substantially parallel to the main axis.

19. The deposition apparatus according to claim 1, wherein the carrier frequency of the radio link is an ISM frequency.

20. The deposition apparatus according to claim 19, wherein the carrier frequency is one of the frequency group consisting of 27 MHz, 40 MHz, 446 MHz, 860 MHz and 2.45 GHz.

21. The deposition apparatus according to claim 1, wherein the radio link is a digital radio link.

22. The deposition apparatus according to claim 1, wherein the deposition chamber is one of the group consisting of a vacuum chamber, a high vacuum chamber and an ultrahigh vacuum chamber.

23. The deposition apparatus according to claim 1, wherein the substrates are to be coated with a thin layer having a layer thickness of one of the range group consisting of between 3 nm to 100 μm and 50 nm to 15 μm.

24. The deposition apparatus according to claim 1, wherein the substrates are to be coated with a material which includes at least a material component from a group of material components consisting of SiO2, TiO2, HfO, TaO, MgF2, Al2O3, ZrO2, PrTiO3, and ZnS.

25. The deposition apparatus according to claim 1, wherein the substrates are to be coated with a metallic material.

26. The deposition apparatus according to claim 1, wherein the substrates are to be coated with a multi-layer system of various materials.

27. A method for controlling an actuator in a deposition apparatus, the deposition apparatus comprising:
a deposition chamber;
at least one substrate holder movably arranged within the deposition chamber for holding substrates to be coated;
radio equipment having at least:
a first radio device which is connected to the substrate holder, and
a second radio device which is arranged at least partially outside the deposition chamber; and
a radio link for transferring information being established at least temporarily between the first radio device and the second radio device;
said method comprising the following steps:
recording at least one measured value by means of a measuring device which is connected to the substrate holder;
transferring the at least one measured value via a radio link established at least temporarily between the first radio device and the second radio device;
processing the at least one measured value in a data processing unit connected to the second radio device into at least one control command; and
transferring the at least one control command via the radio link established at least temporarily between the second radio device and the first radio device to the actuator.

28. A method for controlling a heating system in a deposition apparatus, the deposition apparatus comprising:
at least one deposition chamber;
at least one substrate holder movably arranged within the deposition chamber for holding substrates to be coated;
radio equipment having at least:
a first radio device which is connected to the substrate holder, and
a second radio device which is arranged at least partially outside the deposition chamber; and
a radio link for transferring information being established at least temporarily between the first radio device and the second radio device;
said method comprising the following steps:
recording at least one measured value by means of a measuring device which is connected to the substrate holder;
transferring the at least one measured value via a radio link established at least temporarily between the first radio device and the second radio device;
processing the at least one measured value in a data processing unit connected to the second radio device into at least one control command; and
transferring the at least one control command via the radio link established at least temporarily between the second radio device and the first radio device to the heating system.
